(19) United States
(12) Patent Application Publication
(10) Pub. No.: US 2025/0252159 A1
(43) Pub. Date: Aug. 7, 2025

(54) DEVICE LINKAGE CONTROL METHOD AND SYSTEM

(71) Applicant: Shenzhen Reolink Technology Co., Ltd., Shenzhen (CN)

(72) Inventor: Kang Li, Shenzhen (CN)

(21) Appl. No.: 19/087,788

(22) Filed: Mar. 24, 2025

(30) Foreign Application Priority Data
Apr. 22, 2024 (CN) 202410397564.7

(51) Int. Cl. G06F 21/10; H04L 9/32

(52) U.S. Cl. CPC G06F 21/1014; H04L 9/3213

(57) ABSTRACT

The present application relates to the technical field of Internet of Things control, and provides a device linkage control method and system. According to the device linkage control method, after detecting information, a main control device determines a controlled device according to a linkage type by querying a linkage parameter table, the controlled device interacts with token information generated by the controlled device, and execution information is sent to the controlled device, so as to achieve a linkage operation on the controlled device. The whole linkage process does not require the participation of a cloud platform, and also does not require a user to input any account and password information, which improves the timeliness of the linkage operation, reduces the delay of the linkage operation, and also reduces the operational difficulty of the linkage operation and improves the user's experience.

### TECHNICAL FIELD

The embodiments of the present application relate to the technical field of Internet of Things control, and particularly relate to a device linkage control method and system.

### BACKGROUND

Internet of Things (IoT) is a hot topic in the field of science and technology today. It collects all kinds of information in real-time by a variety of information sensors, the radio frequency identification technology, the global positioning system, infrared sensors, laser scanners and other devices and technologies to achieve ubiquitous connection between things and things, and things and people, and achieve intelligent perception, identification and management of goods and processes.

In the modern society, the application range of the linkage of IoT device is very wide, covering various fields. In the family life, the intelligent home system can achieve the linkage control of household appliances. In the industrial production, the running status and process parameters of production equipment can be real-time monitored by the sensors and data acquisition equipment to find and adjust the problems in time and improve the production efficiency and product quality. In the urban management, by the sensors and monitoring equipment, the information of traffic flow, air quality, filling degree of sundries barrels and so on can be monitored in real time, which helps the urban managers to better plan the traffic route and adjust the environmental management strategy. The IoT network achieves the intelligent connection between things by the linkage of various devices and technologies.

In order to achieve the linkage between the IoT devices, the cloud platform can be built, and the device information of various IoT devices can be stored on the cloud platform. All the linkage operations can be forwarded by the cloud platform. In this way, all the device information is required to be transferred and operated by the cloud platform, on the one hand. There will be a relatively large delay in the linkage operation between the devices, and the real-time response of the linkage action is not enough. On the other hand, since all the interactions are performed by the cloud platform, the IoT device is required to access the external network, and some users do not want their IoT device to access the external network for absolute security, but only want to use it in the local area network. Thus, this scheme cannot meet the requirements; in the third aspect, since all the information of the IoT devices is stored on the cloud platform, the security of the cloud platform becomes a very important bottleneck, and the cloud platform may cause the leakage of the device information of the IoT devices. Once the home IoT devices are invaded by the outside, it will cause a very big security hidden danger.

It can be seen therefrom that when the existing IoT devices are operated in linkage, the adopted linkage control method often has the problems of low real-time performance and poor security, resulting in a relatively poor user experience.

### SUMMARY

In view of the above-mentioned problems, the embodiments of the present application provide a device linkage control method, and a device linkage control system, which solve the technical problems of low timeliness and poor security of linkage between different Internet of Things (IoT) devices existing in the prior art.

According to an aspect of an embodiment of the present application, it provides a device linkage control method applied to a main control device for connecting to one or more controlled devices via a network. The method includes: acquiring detection information monitored by the main control device in real time, and determining a linkage type corresponding to the detection information; determining a controlled device required to perform a linkage operation based on a preset linkage parameter table and the linkage type, and acquiring address information and execution information of the controlled device from the linkage parameter table; establishing a network connection with the controlled device according to the address information; sending token information to the controlled device to verify validity of the token information; receiving authorization login information sent by the controlled device, and enable the main control device to log in the controlled device when the token information is valid; and sending the execution information to the controlled device through the network connection, so that the controlled device performs a linkage operation according to the execution information.

According to another aspect of an embodiment of the present application, it further provides a device linkage control method applied to a controlled device for connecting to a main control device via a network. The method the method includes: receiving a network connection request sent by a main control device, and establishing a network connection with the main control device; receiving token information sent by the main control device; verifying the token information and generating authorization login information after the verification is passed; sending the authorization login information to the main control device for enabling the main control device to log in the controlled device; receiving execution information sent by the main control device through the network connection, and performing a linkage operation according to the execution information.

According to a third aspect of an embodiment of the present application, it further provides a device linkage control system. The system includes a main control device and one or more controlled devices. The main control device is configured for monitoring detection information in real time, determining a linkage type corresponding to the detection information, determining one of the controlled devices required to perform a linkage operation based on a preset linkage parameter table and the linkage type, and acquiring address information and execution information of the controlled device from the linkage parameter table, sending a network connection request to the controlled device according to the address information.

The controlled device is configured for establishing a network connection with the main control device the according to the network connection request of the main control device, receiving token information sent by the main control device, verifying the token information and generating authorization login information after the verification is passed. sending the authorization login information to the main control device for enabling the main control device to log in the controlled device.

The main control device is further configured for receiving authorization login information sent by the controlled device through the network connection; sending the execution information to the controlled device through the network connection.

The controlled device is further configured for receiving execution information sent by the main control device, and performing a linkage operation according to the execution information.

According to the device linkage control method provided in the embodiments of the present application, the main control device determines a target controlled device according to a linkage type by querying a linkage parameter table, the target controlled device interacts with token information generated in advance by the target controlled device, and execution information is sent to the target controlled device, so as to achieve a linkage operation on the controlled device. The whole linkage process does not require the participation of a cloud platform, and also does not require a user to input any account and password information, which improves the timeliness of the linkage operation, reduces the delay of the linkage operation, and also reduces the operational difficulty of the linkage operation and improves the user's experience.

### BRIEF DESCRIPTION OF THE DRAWINGS

The drawings are only for purposes of illustrating the embodiments and are not to be construed as limiting the application. Moreover, like reference numerals designate like parts throughout the drawings. In the drawings:

FIG. 1A is a network architecture diagram of a device linkage control method applied to a local area network according to an embodiment of the present application;

FIG. 1B is a network architecture diagram of a device linkage control method applied to a P2P network according to an embodiment of the present application;

FIG. 2 is a schematic flow diagram of a main control device side linkage control method according to an embodiment of the present application;

FIG. 3 is a schematic flow diagram of a main control device side linkage control method according to another embodiment of the present application;

FIG. 4 is a schematic flow diagram for determining a target controlled device according to an embodiment of the present application;

FIG. 5 is a schematic flow diagram of a controlled device linkage control method according to an embodiment of the present application;

FIG. 6 is a schematic flow diagram of a controlled device linkage control method according to another embodiment of the present application;

FIG. 7 is an interaction flow diagram of a device linkage control method according to an embodiment of the present application;

FIG. 8 is a signaling flow diagram of a device linkage control system according to an embodiment of the present application;

FIG. 9 is a schematic diagram of an associated flow of a device linkage control system according to an embodiment of the present application; and

FIG. 10 is a structurally schematic view of a main control device or a controlled device according to an embodiment of the present application.

### DETAILED DESCRIPTION

Hereinafter, exemplary embodiments of the present application will be described in more detail with reference to the accompanying drawings. Although illustrative embodiments of the present application are shown in the accompanying drawings, it should be understood that the application may be embodied in various forms and should not be construed as limited to the embodiments set forth herein.

The embodiment of the present application provides a device linkage control method, a main control device, a controlled device and a device linkage control system, which can be applied to a variety of scenarios and also to various Internet of Things (IoT) devices. For example, the invention can be applied to the control of home appliances in smart home, the linkage control between sensors and data acquisition equipment in industrial production, and the control between sensors and monitoring equipment in the production control process, etc.

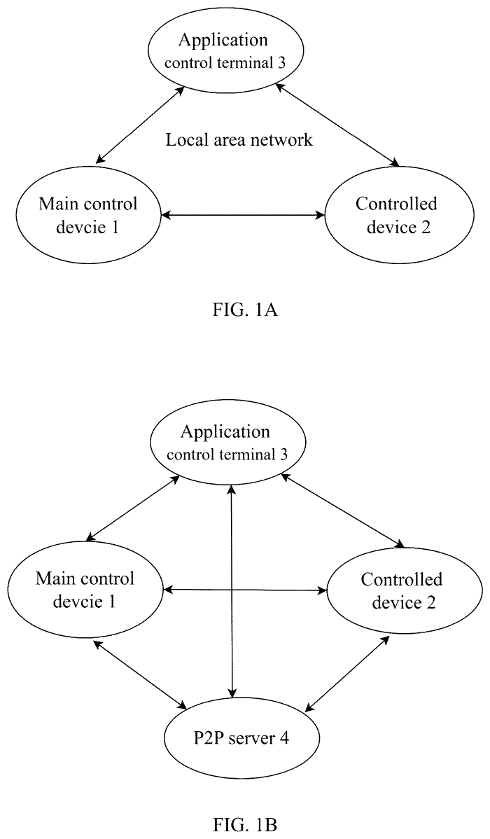

FIG. 1A shows a network architecture diagram of a device linkage control method, a device and a system under a local area network architecture provided by an embodiment of the present application. FIG. 1B shows a network architecture diagram of a device linkage control method, a device and a system under a peer to peer (also called as point to point, P2P) network architecture provided by an embodiment of the present application. Under the framework of the local area network, a main control device 1, a controlled device 2 and an application control terminal 3 respectively access a router in the local area network via an IP protocol, and access and interact under the control of the router. Under the P2P network architecture, the main control device 1, the controlled device 2 and the application control terminal 3 are both a client and a server, and the P2P connection is established by a P2P server 4 during initialization. During the normal practice, the main control device 1, the controlled device 2 and the application control terminal 3 can all communicate and exchange data directly with each other, without forwarding by the P2P server 4. The P2P architecture improves the scalability, flexibility and efficiency of the network, and can improve the security and privacy of data transmission to a certain extent.

With continued reference to FIG. 1A or FIG. 1B, the device linkage control system of the present embodiment includes a main control device 1, a controlled device 2, and an application control terminal 3. In the embodiment of the present application, taking the main control device 1 as a network camera (for example, an IP camera), the controlled device 2 as an alarm, and the application control terminal 3 as a mobile phone end APP as an example, the application scenario of the embodiment of the present application is described. The network camera is a camera that can be networked, including but not limited to a monitoring camera, a home camera, and various production monitoring probes, etc. The alarm can be a light alarm, with illumination and horn alarm functions, etc. Both the network camera and the alarm have networking functions, such as accessing a local area network by an IP protocol, performing a P2P ad hoc network by the P2P technology, and performing an ad hoc network by other means. In a common application scenario, the user can set the linkage operation of the network camera and the alarm, such as, when the network camera detects a particular picture, such as a stranger, the alarm is controlled to operate as an alarm. The device linkage control method, the device and the system provided in the embodiments of the present application can also be applied to other various scenarios, and the description thereof will not be repeated in the embodiments of the present application.

In the embodiment of the present application, the main control device 1, as a network camera, is mainly used for photographing a pre-set area to acquire detection information, and the network camera also has a networking function, a data analysis function and a data storage function, and can analyze the detection information and determine the linkage type of the detected content. For example, when a face image is detected, the network camera can analyze the face image so as to judge whether the face is a stranger, and trigger a corresponding linkage type according to the judgement result. The network camera can store data, such as, a linkage parameter table is stored, and a corresponding linkage execution operation can be triggered according to a linkage type by means of the linkage parameter table. The controlled device 2, as an alarm, is mainly used for performing a corresponding linkage operation according to the execution information sent by the main control device 1. The controlled device 2 is required to have a networking function, a token generation function and a storage function. The token information can be allocated to an Internet of Things (IoT) device associated therewith by means of the token generation function. In a subsequent association process, the token information provided by the accessed main control device 1 is verified so as to ensure legal access. When the accessed main control device 1 is a qualified device, a linkage operation is performed according to the execution information provided by the main control device 1. The application control terminal 3, as a mobile phone APP, is used for connecting with a network camera and an alarm when configuration information is initialized or required to be changed, and configuring the network camera and the alarm, including but not limited to configuring a communication interface, network parameters, linkage parameters, etc.

It should be noted that the application control terminal 3 is only required to access when the main control device 1 and the controlled device 2 are initialized, or when the configuration is required to be changed. When the main control device 1 and the controlled device 2 complete configurations, the application control terminal 3 does not need any access and operation. The access, verification and control operations are directly performed between the main control device 1 and the controlled device 2, without the intervention of any third party device. Therefore, the device linkage control method provided in the present embodiment is divided in two stages. When the first stage is initializing or changing the configuration, the application control terminal 3 is required to interact with the main control device 1 and the controlled device 2. The second stage is a normal linkage stage, and in this stage, the main control device 1 and the controlled device 2 are complete independently.

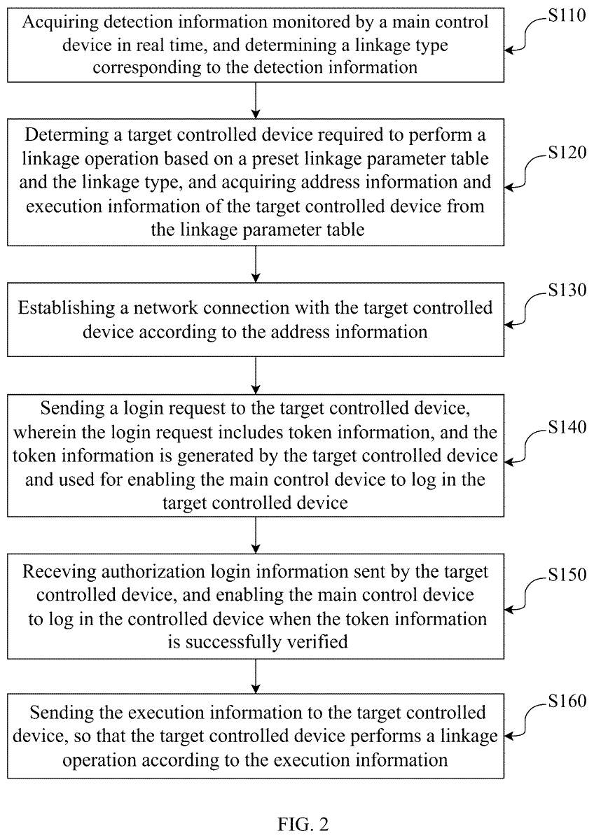

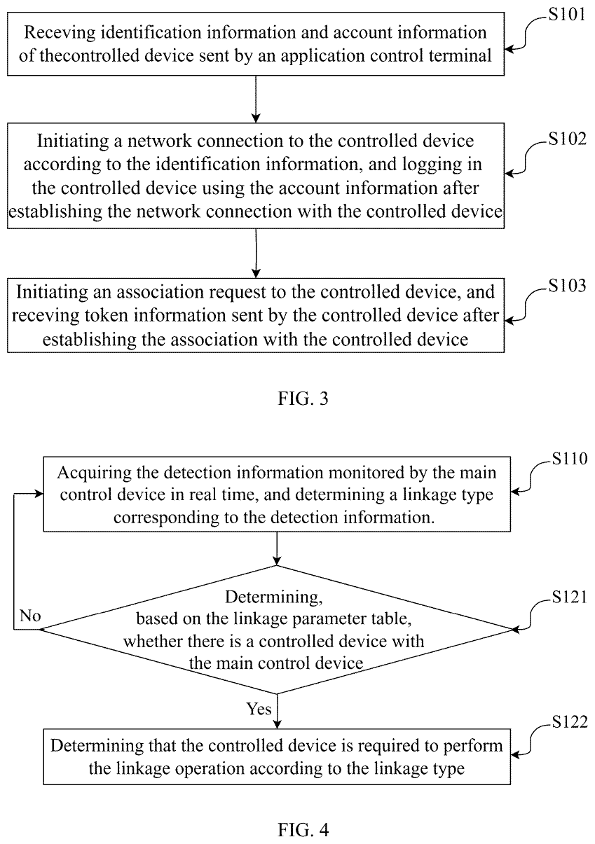

FIG. 2 shows a flow diagram of a device linkage control method provided by an embodiment of the present application, which is applied to a main control device 1. The embodiment of the present application will be specifically explained by taking the network architecture shown in FIG. 1A or FIG. 1B as an example. The method includes:

Step S110, acquiring detection information monitored by the main control device in real time, and determining a linkage type corresponding to the detection information.

When the main control device 1 and the controlled device 2 complete the initialization configuration under the control of the application control terminal 3, the main control device 1 and the controlled device 2 are in a normal working state. Specifically, the main control device 1 acquires detection information of the surrounding environment monitored by the main control device 1 in real time and determines a linkage type corresponding to the detection information.

Taking a network camera and an alarm as an example, the network camera will take a picture of a specific area, and acquire detection information of the specific area monitored by the network camera in real time, such as, image or video information. After the detection information is acquired, the network camera will analyze the detection information, such as, determining the content contained in the detection information by image extraction or analyzing the image by a pre-set analysis model, and determining a linkage type corresponding to the content according to configuration information pre-set in the network camera. For example, the linkage type may be a human figure, a vehicle or an animal, etc. When it is determined by analyzing the detection information that the content contained therein is a human figure, the linkage type is determined to be the human figure. When it is determined by analyzing the detection information that the content contained therein is an animal, such as a kitten, it is determined that the linkage type is the animal.

The above-mentioned image extraction and analysis model can be operated by using various algorithms, and is not limited in the embodiments of the present application.

Step S120, a target controlled device required to perform a linkage operation is determined based on a preset linkage parameter table and according to the linkage type, and address information and execution information of the target controlled device are acquired from the linkage parameter table.

In the present embodiment, when the application control terminal 3 initializes the main control device 1, a linkage parameter table is set for the main control device 1. For example, taking a network camera, an alarm and a mobile phone-side APP as an example, when the mobile phone-side APP initializes the network camera, a linkage parameter table is set for the network camera. Here, the relationship between the linkage type and the linkage operation is configured in the linkage parameter table. As shown in Table 1, a common linkage parameter table is shown.

TABLE 1

| | | Address | Execution |
|---|---|---|---|
| Action ID | Linkage type | information | information |
| 0 | Human figure | UID1 | Alarming |
| 1 | Vehicle | UID1 | Illumination |
| 2 | Day and night | UID2 | Switching mode |
| | switching | | |

In table 1, a plurality of linkage types are included, and address information and execution information of a controlled device 2 correspond to each linkage type. Herein, the address information can be unique identification (UID) information of the controlled device 2 and can also be MAC address information, and the function thereof is to enable a main control device 1 to find a corresponding controlled device 2. The execution information is action information of the controlled device 2. One main control device 1 may be associated with a plurality of different controlled devices 2. Different linkage types may correspond to the same controlled device, and may also correspond to different controlled devices 2. Likewise, the execution information may also be various.

After determining the linkage type, the main control device 1 can determine a target controlled device 2, i.e., a controlled device 2 required to perform a linkage operation, from a plurality of controlled devices 2 by querying in the linkage parameter table. For example, when the linkage type determined by the network camera is the human figure, it can be determined that the address of the target controlled device 2 is UID1. Assuming that the controlled device 2 corresponding to UID1 is an alarm, the action performed by the alarm is an alarm.

Step S130, a network connection is established with the target controlled device according to the address information.

Since the main control device 1 and the controlled device 2 are in a long-term working state, in order to reduce power consumption, the main control device 1 and the controlled device 2 are often in an off-line state when they are in a dormant or non-working state. Therefore, in FIG. 1A or FIG. 1B, when both the main control device 1 and the controlled device 2 are in an off-line state, they should establish a network connection.

Taking the network camera, the alarm and the APP at the mobile phone end as an example, the network camera and the alarm all have networking functions. For example, they may be connected via a local area network, or may be connected in a P2P manner, and are not limited herein. When the network camera is required to trigger the linkage operation, the network camera will actively initiate a network connection request to the alarm so as to establish a network connection.

Step S140, a login request is sent to the target controlled device, wherein the login request includes token information, and after the token information establishes an association between the main control device and the target controlled device, verification information is generated by the target controlled device and used for enabling the main control device to log in the target controlled device.

In the present embodiment, taking a network camera and an alarm as an example, after the network camera establishes a network connection with the alarm, the network camera is required to establish a trusted connection with the alarm in order to be able to perform information interaction with the alarm, i.e., the network camera is required to log in the alarm. Therefore, after a network connection is established between the network camera and the alarm, the network camera is required to send a login request to the alarm, and only after the alarm has verified the login information of the network camera, can the network camera log in successfully and can communicate with the alarm.

The login request sent by the network camera contains token information. Herein, the token information is generated by the alarm and allocated to the network camera during the first stage, namely, when the configuration is initialized or changed, and is used for verifying the login request of the main control device so as to ensure the validity of the login. The token is usually an encrypted string containing the user's unique identification, time stamp, etc. When the user accesses the protected resource, the system will verify the validity of the token information to ensure the legitimacy of the request.

When generating the token information, the alarm can be generated by using a variety of security algorithms, which are not limited in the present embodiment. At the same time, in order to facilitate the subsequent network cameras to log in multiple times, the valid time of the token information can be set. A permanent valid time can be set, and an invalid period can also be set, so as to ensure the security of logging in.

In the embodiment of the present application, the controlled device 2 can generate token information for a plurality of main control devices 1, and verify the login of the plurality of main control devices 1, without performing a token service via a special cloud platform, which greatly simplifies the system architecture. At the same time, the main control device 1 logs in by means of a token, which avoids the tedious logging in by means of an account name and a password, and simplifies the login process.

Step S150, authorization login information sent by the target controlled device is received, wherein the authorization login information is generated after the target controlled device verifies the token information.

As shown in FIG. 1a or FIG. 1b, when the controlled device 2 receives the token information sent by the main control device 1, the controlled device 2 checks the token information. When the check is passed, the controlled device 2 will send authorization login information to the main control device 1, so as to inform the main control device 1 of the check result.

Step S160, the execution information is sent to the target controlled device, so that the target controlled device performs a linkage operation according to the execution information.

In the present embodiment, taking the network camera and the alarm as an example, when the network camera receives the authorization login information, indicating that the login is successful and the alarm can be operated, the network camera transmits the execution information to the alarm. After the alarm receives the execution information, such as, if the execution information is an alarm, the alarm device initiates an alarm operation.

It can be seen from the above-mentioned embodiments that after detecting the information, the main control device 1 determines the controlled device 2 as the target controlled device according to the linkage type by querying the linkage parameter table, interacts with the controlled device 2 via the pre-generated token information, and sends the execution information to the controlled device 2, so as to achieve the linkage operation on the controlled device 2. The whole linkage process does not require the participation of a cloud platform, and also does not require a user to input any account and password information, which improves the timeliness of the linkage operation, reduces the delay of the linkage operation, and also reduces the operational difficulty of the linkage operation and improves the user's experience.

In order to achieve the initialization operation and the configuration change operation for the main control device 1 and the controlled device 2, as shown in FIG. 2, the embodiment of the present application proposes an operation flow for the first stage, which is required to be performed before step S110 at the time of initialization. When the configuration of the main control device 1 and the controlled device 2 is required to be changed after the initialization, the operation can be performed at any time, which is not limited in the embodiments of the present application. For a clearer presentation, an embodiment of the present application is described with reference to FIG. 1a or FIG. 1b, and the operation flow specifically includes:

Step S101, identification information and account information of the controlled device 2 sent by an application control terminal 3 is received.

In the present embodiment, taking a network camera, an alarm and a mobile phone-side APP as an example, in an initialization stage, a user adds the network camera and the alarm via a private protocol on the mobile phone APP, and establishes a network connection with the network camera and the alarm. After establishing the network connection, the mobile phone APP firstly acquires account information of the alarm so that the network camera required to be associated logs in the controlled device to establish an association, and sends identification information and account information corresponding to the alarm to the network camera, wherein the account information can be user name and password information, etc.

Step S102, a network connection is initiated to the controlled device 2 according to the identification information, and the controlled device 2 is logged in using the account information after establishing the network connection with the controlled device 2.

In the present embodiment, in the step 101, the network camera and the alarm respectively establish a network connection with the mobile phone APP, but no network connection is established between the network camera and the alarm. In order to associate the network camera with the alarm, a network connection is required to be established between the network camera and the alarm. The network camera can establish a connection with the alarm by a local area network according to the identification information, and can also establish a connection with the alarm by a P2P protocol.

Since the network camera and the alarm are logged in for the first time, when the network camera and the alarm establish a network connection, the network camera is required to log in the alarm by the account information provided by the APP at the mobile phone.

Step S103, an association request is initiated to the controlled device, and token information sent by the controlled device 2 is received after establishing the association with the controlled device 2.

In the present embodiment, when the network camera and the alarm are connected and logged in the alarm, the network camera sends an association request to the alarm to cause the alarm to generate token information for the network camera according to the association request.

When the alarm generates token information and sends the token information to the network camera, the network camera receives the token information and saves the token information, so as to directly use the token information to log in during the subsequent linkage control. This approach does not require additional operations, nor does it require entry of account names and passwords, which improves security and linkage efficiency.

In order to improve the real-time performance of the linkage operation performed by the main control device 1 on the controlled device 2 and reduce the linkage time delay, the embodiment of the present application further performs an optimization operation on the step S120 in the above-mentioned embodiment, and specifically as shown in FIG. 4, including:

Step S121, it is determined whether there is a controlled device 2 having established an association with a main control device 1 in the linkage parameter table.

After the step 110, when in the step 110, the main control device 1 monitors the detection information by detection, and determines a linkage type corresponding to the detection information. The main control device 1 further queries a pre-stored linkage parameter table, and determines whether there is a controlled device 2 in the linkage parameter table that has established an association with the main control device 1.

If there is no controlled device 2 having established an association with the main control device 1 according to the linkage parameter table, it is indicated that for the linkage type, the main control device 1 does not need to perform any linkage operation, and it is sufficient to directly return to the step 110 to continue the detection.

If there is a controlled device 2 in the linkage parameter table that has established an association with the main control device 1, step S122 is continued.

Step S122, a target controlled device 2 is determined to perform the linkage operation according to the linkage type.

When there is a controlled device 2 having established an association with the main control device 1 according to the linkage parameter table, the controlled device 2 corresponding to the linkage type is determined by the linkage type, and the controlled device 2 is determined as a target controlled device 2 that is required to perform the linkage operation.

The embodiment of the present application firstly judges whether there is a controlled device 2 which has established an association with a main control device 1 by the linkage parameter table, which can quickly determine the next operation, reduces the system delay, improves the real-time response of the main control device 1 to the linkage operation, and optimizes the user experience.

In order to improve the real-time response of the main control device 1 and reduce the operation time delay, the embodiment of the present application also proposes a further improvement, as shown in table 2. In the embodiment of the present application, the linkage time range information is added to the linkage parameter table.

TABLE 2

| Action | | Linkage time | Address | Execution |
|---|---|---|---|---|
| ID | Linkage type | range | information | information |
| 0 | Human figure | 09:00-21:00 | UID1 | Alarming |
| 1 | Vehicle | 12:00-18:00 | UID1 | Illumination |
| 2 | Day and night | 18:00-22:00 | UID2 | Switching |
| | switching | | | mode |

Taking the network camera, the alarm and the mobile phone APP as examples, in order to improve the real-time response of the network camera and reduce the operation time delay, in the embodiment of the present application, the linkage time range parameter is set in the linkage parameter table. After the linkage type is determined, the linkage time range is further determined, and the alarm which is required to be operated in the linkage operation is gradually determined, so as to reduce the amount of information acquired once and reduce the delay of the network camera.

Specifically, when the network camera acquires the detection information, the time information corresponding to the detection information, i.e., the time when an event occurs in the detection information, is recorded. When querying the linkage parameter table to determine corresponding information of the alarm, it is firstly judged whether the time information corresponding to the detection information is within a linkage time range corresponding to the linkage type. If the time information is within the time range, it is determined that the address information and execution information corresponding to the linkage type are address information and execution information of the alarm.

For example, when the detection information acquired by the network camera at 10:00 is a vehicle, it is determined that the corresponding detection type is a vehicle. Since the time when the vehicle is detected is 10:00, which is not within the linkage time range of 12:00-18:00 corresponding to the vehicle in the linkage parameter table, the network camera does not need to perform any operation.

When the detection information acquired by the network camera at 13:00 is a vehicle, it is determined that the corresponding detection type is a vehicle. Also, since the time when the vehicle is detected at 13:00 falls within the linkage time range of 12:00-18:00 corresponding to the vehicle in the linkage parameter table, the network camera further acquires the address information “UID1” of the alarm and the execution information “illumination”.

In this way, the embodiment of the present application improves the real-time response of the main control device 1 and reduces the linkage time delay between the devices.

Furthermore, in order to obtain the linkage operation result between the main control device 1 and the controlled device 2 more accurately, in the embodiment of the present application, after the controlled device 2 performs the linkage operation, a new linkage operation is further proposed.

Specifically, with continuing reference to FIG. 1A or FIG. 1B, after the controlled device 2 completes the linkage operation, a linkage operation result is sent to the main control device 1. The linkage operation result includes a time stamp of the controlled device 2 performing the linkage operation, and the time stamp is used for recording the time when the linkage operation is performed.

After the main control device I receives the linkage operation result, the time stamp of the controlled device 2 executing the linkage operation is acquired to compare the time information when the detection information is acquired with the time stamp and acquire the time length between the both. The time length is compared with a pre-set threshold value, and it determines whether a linkage delay has occurred in the linkage operation.

For example, the pre-set threshold value is 30 seconds, the time corresponding to the detection information is 11:30:10, and the time stamp returned by the controlled device 2 is 11:30:35, the time duration between the two is 25 seconds, and less than the pre-set time threshold value of 30 seconds, indicating that the linkage operation is not delayed, and falls within a normal category.

Assuming that the time stamp returned by the controlled device 2 is 11:30:50, and the time duration between the two is 40 seconds, exceeding the pre-set time threshold value by 30 seconds, it indicates that the linkage operation is delayed, and the system is required to be checked and corrected. At this time, the main control device I will actively send the information of the controlled device 2 with the linkage delay to the application control terminal 3, so as to facilitate the administrator to perform device maintenance and inspection.

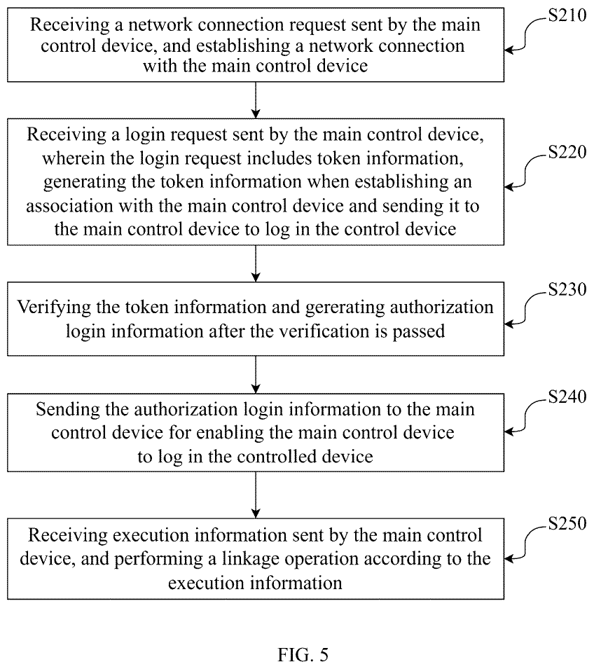

In another embodiment of the present application, a device linkage control method is also provided, which is applied to a controlled device 2, as shown in FIG. 5, and includes:

Step S210: a network connection request sent by the main control device 1 is received and a network connection is established with the main control device 1.

The controlled device 2 is also applied to a network architecture as shown in FIG. 1a or FIG. 1b, and is used to perform a linkage operation with the main control device 1 after performing initialization or changing configuration under the control of an application control terminal 3. As shown in FIG. 1A or FIG. 1B, the controlled device 2 is an alarm, and the main control device 1 is a network camera.

In the present embodiment, after the alarm receives a network connection request sent by the network camera, a network connection is established with the network camera, and the network connection may be a local area network established by the user himself or herself, or may be a connection via a P2P network, or may be connected using other technologies, such as Bluetooth, etc.

Step S220, a login request sent by the main control device 1 is received, wherein the login request includes token information, and the token information is verification information generated when establishing an association with the main control device 1 and sent to the main control device 1 so as to enable the main control device 1 to login in.

In the present embodiment, after establishing a network connection with the network camera, a login request sent by the network camera is received, and the login request includes token information, which is allocated to the network camera when the alarm initializes or changes a configuration.

Step S230, the token information is verified, and authorization login information is generated after the verification is passed.

In the present embodiment, the alarm verifies the token information, including verifying the validity of the token information, a time stamp, etc. In the embodiment of the present application, in order to facilitate the quick login between the network camera and the alarm, a convenient token verification method can be used, and identity verification can be performed without inputting a password. Of course, it is also possible to set a check password in the main control device in advance, and the alarm checks the token information according to the check password.

When the verification is passed, the alarm allows the network camera to log in, and sends authorization login information to the network camera.

Step S240, the authorization login information is sent to the main control device 1 for enabling the main control device 1 to log in the controlled device 2.

In the present embodiment, the alarm transmits the authorization login information to the network camera through the established network connection.

Step S250, execution information sent by the main control device 1 is received, and a linkage operation is performed according to the execution information.

In the present embodiment, the main control device 1 sends the execution information to the controlled device 2 through the network connection. For example, after receiving the authorization login information, the network camera will send the execution information in the linkage parameter table to the alarm. After receiving the execution information, the alarm will perform a linkage operation according to the execution information.

It can be seen from the above-mentioned embodiments that after establishing a network connection with the main control device 1, the controlled device 2 controls the access of the main control device via the verification token information. After the main control device 1 accesses the controlled device 2, the controlled device 2 receives the execution information sent by the main control device, and performs a linkage operation according to the execution information. The whole linkage process does not require the participation of a cloud platform, and also does not require a user to input any account and password information, which improves the timeliness of the linkage operation, reduces the delay of the linkage operation, and also reduces the operational difficulty of the linkage operation and improves the user's experience.

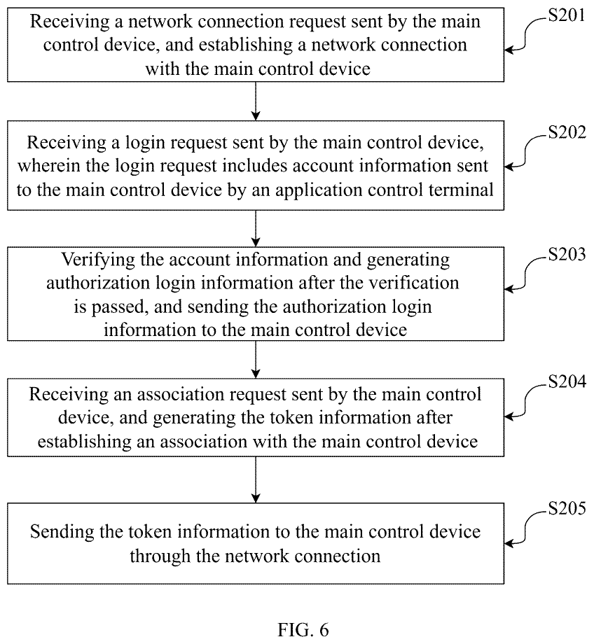

Further, in order to achieve the initialization operation and the configuration change operation for the main control device 1 and the controlled device 2, as shown in FIG. 6, the embodiment of the present application proposes an operation flow for the first stage at the controlled device 2. Herein, the operation flow is required to be performed before step S210 at the time of initialization. If the configuration is changed, the execution step of the operation flow is not specifically required, and can be performed according to needs. For a clearer presentation, an embodiment of the present application is described with reference to FIG. 1, and the operation flow specifically includes:

Step S201, a network connection request sent by the main control device 1 is received and a network connection is established with the main control device 1.

In the present embodiment, taking the network camera, the alarm and the mobile phone-side APP as an example, during the initialization stage or changing the configuration, the network camera and the alarm respectively establish a network connection with the mobile phone-side APP, but no network connection is established between the network camera and the alarm. In order to associate the network camera with the alarm, a connection is required to be established between the network camera and the alarm. The network camera can establish a connection with the alarm by a local area network according to the identification information, and can also establish a connection with the alarm by a P2P protocol.

Step S202, a login request sent by the main control device 1 is received, wherein the login request includes account information sent to the main control device by an application control terminal 3.

In the present embodiment, after the network connection between the network camera and the alarm is established, since the network camera and the alarm are logged in for the first time, the network camera is required to log in the alarm via the account information provided by the APP at the mobile phone end. The account information provided by the APP at the mobile phone end is included in the login request sent by the network camera to the alarm for the network camera to log in the alarm.

Step S203, the account information is verified, authorization login information is generated after the verification is passed, and the authorization login information is sent to the main control device 1.

In the present embodiment, the alarm verifies the account name and password after receiving the account information transmitted from the network camera, and generates the authorization login information after the verification is passed, allowing the login operation of the network camera.

Step S204, an association request sent by the main control device 1 is received, and token information is generated after establishing an association with the main control device 1.

In the present embodiment, after receiving the authorization login information, the network camera sends an association request to the alarm so as to establish an association relationship with the alarm for a subsequent linkage operation. The association operation is performed in an initialization stage. When the initialization is completed, no further association operation is required to be performed between the network camera and the alarm.

When the association is established, the alarm generates token information for the network camera to facilitate subsequent logins by the network camera.

Step S205, the token information is sent to the main control device 1 through the network connection.

In the present embodiment, the token information is sent to the network camera in an encrypted manner, stored by the network camera, and used in subsequent logins. The token information is usually an encrypted string containing the user's unique identification, time stamp, etc. When the user accesses the protected resource, the system will verify the validity of the token to ensure the legitimacy of the request.

In the embodiment of the present application, the token information is generated by the controlled device 2, and the main control device 1 directly uses the token information to log in during subsequent linkage control according to the token information, without requiring additional operation, and the account name and password are also not required to be input, thus improving security and linkage efficiency.

In some embodiments, when the target controlled device 2 performs a linkage operation according to the execution information sent by the main control device, it may occur that the target controlled device 2 is performing other linkage operations. In this case, it may occur that there is a conflict of execution actions. The embodiments of the present application propose further optimization operations for this case.

In the embodiment of the present application, with continuing reference to FIG. 1A or FIG. 1B, when the controlled device 2 receives the execution information sent by the main control device 1, it is judged whether the execution information is the same as the current execution information. Herein, the current execution information is generated on a current operation being executed by the controlled device 2. For example, the execution information is an alarm. When the alarm receives the execution information, the illumination operation is being performed, and then the current execution information is illumination.

If it is found that the execution information is the same as the current execution information, the controlled device 2 continues to perform an operation linkage according to the current execution information, and after completing the current operation, continues to perform a linkage operation according to the execution information.

If it is found that the execution information is not the same as the current execution information, the controlled device 2 may have different options according to preset rules. For example, the execution information can be ignored or rejected according to a pre-set execution strategy, or a linkage operation is performed according to the execution information after the operation linkage is performed according to the current execution information.

The above-mentioned embodiment solves the problem that the controlled device 2 collides with the linkage operation when the controlled device 2 is linked, and can avoid confusion of the controlled device 2 and improve the reliability of the device.

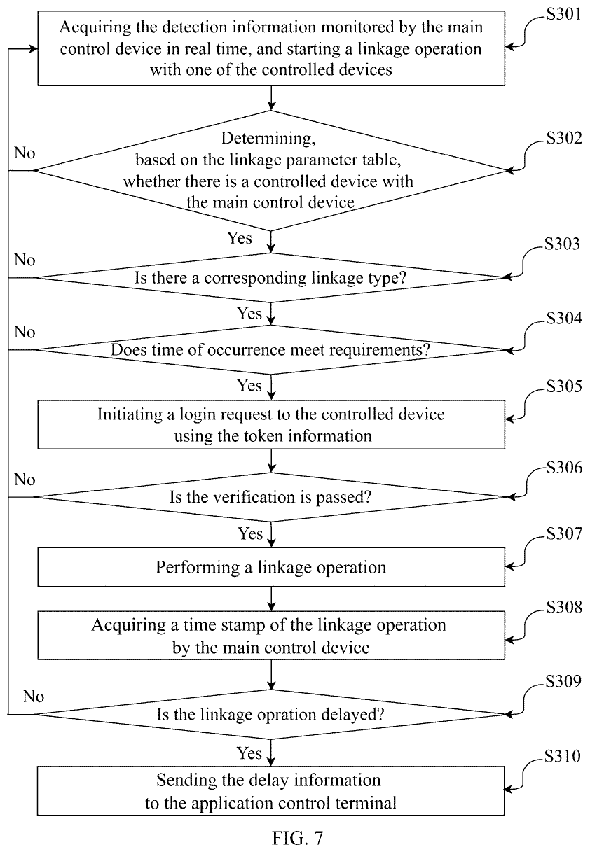

In order to better explain the process of the main control device 1 and the controlled device 2 executing the device linkage control method, FIG. 7 shows a complete execution flow diagram, with continuing reference to FIG. 1A or FIG. 1B, which specifically includes:

Step S301, the main control device 1 acquires detection information monitored in real time by the main control device 1, and starts a linkage operation with one of the controlled devices 2.

When working, the main control device 1 performs detection scanning for a specific area. When it is judged that the acquired detection information complies with a starting condition, a linkage operation is started. For example, when it is detected that a person enters, or a vehicle enters, a linkage operation is initiated, and a linkage type is determined.

Step S302, it is determined, based on the linkage parameter table, whether there is a controlled device 2 with an established association.

When starting a linkage operation, the main control device 1 judges, according to the linkage type, whether there is a controlled device 2 having established an association in the linkage parameter table. If so, it turns to a step S303; otherwise, it turns to the step S301 to continue the detection scanning.

Step S303, it is judged whether there is a corresponding linkage type in the linkage parameter table.

If there is a controlled device 2 for which an association has been established, the main control device judges whether there is a corresponding linkage type in the linkage parameter table. If there is a corresponding linkage type, it turns to a step S304. If there is no corresponding linkage type, it turns to the step S301 to continue the detection.

Step S304, it is judged whether the time of occurrence meets the requirements.

When there is a corresponding linkage type, the main control device 1 judges whether the time when the linkage type occurs complies with the linkage time range recorded in the linkage parameter table. If it is within the linkage time range, it turns to a step S305; otherwise, it turns to the step 301 to continue the detection.

Step S305, the main control device 1 initiates a login request.

The main control device 1 initiates a login request to the controlled device 2 using the token information.

Step S306, it is judged whether the verification is passed.

After receiving the login request sent by the main control device 1, the controlled device 2 verifies the token information, and if the verification is passed, returns authorization login information to the main control device 2.

After receiving the authorization login information, the main control device 1 sends the execution information to the controlled device 2, and jumps to a step S307. If the verification is not passed, it turns to the step S301 to continue the detection.

Step S307, the controlled device 2 performs a linkage operation.

The controlled device 2 receives the execution information sent by the main control device, and executes a linkage operation according to the execution information.

Step S308, the main control device 1 acquires a time stamp of the linkage operation;

After the controlled device 2 completes the linkage operation according to the execution information, the time stamp of the linkage operation is sent to the main control device 1, and the main control device 1 acquires the time stamp of the linkage operation.

Step S309, it is judged whether the linkage is delayed.

The main control device 1 judges whether a delay occurs according to the time stamp of the linkage operation and the time information about the linkage type. If the linkage delay occurs, it goes to a step S310. If there is no linkage delay, the process goes to the step S301, the linkage operation is completed, and the detection scanning is continued by the main control device 1.

Step S310, the main control device 1 sends the delay information to the application control terminal 3.

The main control device 1 sends the linkage delay information to the application control terminal 3, so that the user processes the linkage delay information.

It can be seen from the above-mentioned embodiments that the embodiments of the present application achieve the linkage operation of the main control device 1 to the controlled device 2. The whole linkage process does not require the participation of a cloud platform, and also does not require a user to input any account and password information, which improves the timeliness of the linkage operation, reduces the delay of the linkage operation, and also reduces the operational difficulty of the linkage operation and improves the user's experience.

Furthermore, some embodiments of the present application also provide a device linkage control system. The linkage control system includes at least one main control device 1 and one or more controlled devices 2 as provided in the above-mentioned embodiments. Also, the system also requires the participation of an application control terminal 3 during an initialization or modification configuration phase, and the network architecture of the device linkage control system is as shown in FIG. 1A or FIG. 1B.

In the device linkage control system, the main control device 1 is configured for acquiring detection information monitored by the main control device 1 in real time, and determining a linkage type corresponding to the detection information. The main control device I also determines a target controlled device 2 according to the linkage type based on a pre-set linkage parameter table. The target controlled device 2 is a controlled device 2 which is required to perform a linkage operation, and acquires address information and execution information of about the target controlled device 2 from the linkage parameter table. The main control device 1 also sends a network connection request to the controlled device 2 according to the address information. The main control device 1 is further configured for sending a login request to the controlled device 2, wherein the login request includes token information, and the token information is the verification information generated by the controlled device 2 and is used for enabling the main control device 1 to log in the controlled device 2. The main control device 1 is further configured for receiving authorization login information sent by the controlled device 2, and sending the execution information to the controlled device 2.

In the device linkage control system, the controlled device 2 is configured for establishing a network connection with the main control device 1 after receiving a network connection request of the main control device 1. The controlled device 2 is further configured for receiving a login request sent by the main control device, verifying the token information and generating authorization login information after the verification is passed, and sending the authorization login information to the main control device 1. The controlled device 2 is further configured for receiving execution information sent by the main control device 1, and performing a linkage operation according to the execution information.

In the initialization or modification configuration phase, the device linkage control system also needs the participation of an application control terminal 3. The application control terminal 3 is configured respectively for establishing a network connection with the main control device 1 and the controlled device 2, acquiring identification information and account information of the controlled device 2, and sending the identification information and account information of the controlled device 2 to the main control device 1.

Furthermore, in an initialization or change configuration phase, the main control device 1 is further configured for initiating a network connection to the controlled device 2 according to the identification information, and after establishing a network connection with the controlled device 2, logging in the controlled device 2 using the account information; and after receiving the authorization login information, initiating an association request to the controlled device 2. The controlled device 2 is further configured for verifying the account information, generating authorization login information after the verification is passed, and sending the authorization login information to the main control device 1; and further configured for establishing an association with the main control device I after receiving the association request, generating token information, and sending the token information to the main control device 1.

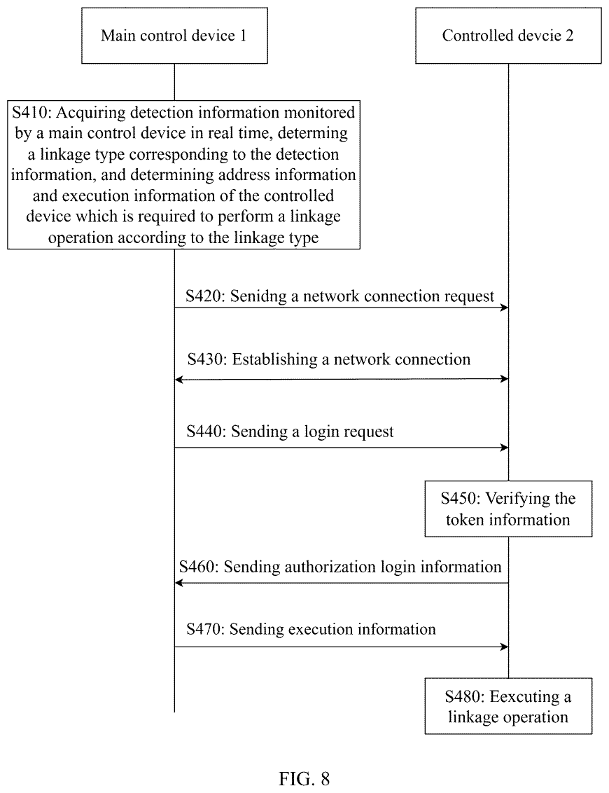

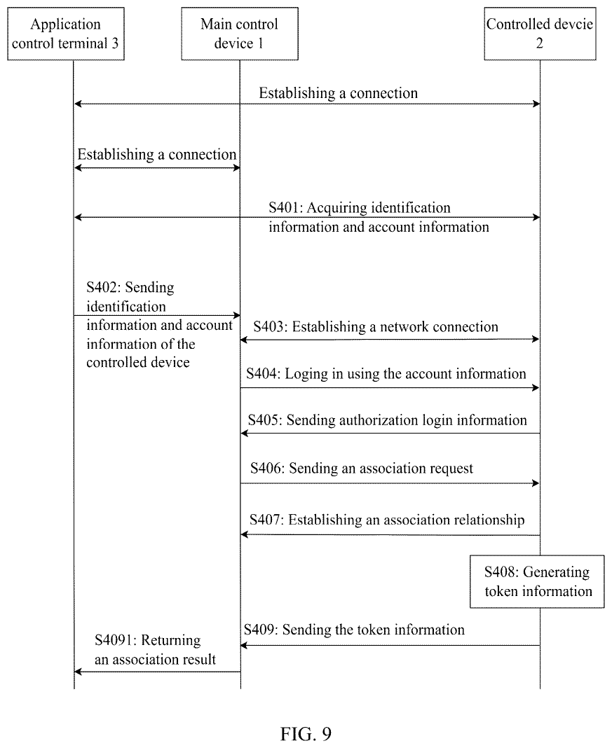

To further illustrate the coordinated device control system, FIG. 8 and FIG. 9 show signaling interaction diagrams between different devices of the device linkage control system according to an embodiment of the present application, as shown in FIG. 8, which is a signaling interaction process diagram at the initialization or modification configuration stage. Before the interaction starts, the application control terminal 3 first is required to establish a network connection with the main control device 1 and the controlled device 3. Embodiments of the present application are described based on the network architecture of FIG. 1A or FIG. 1B.

Step S401, identification information and account information are acquired.

The application control terminal 3 interacts with the controlled device 2 to acquire account information capable of logging in the controlled device 2, including a login user name and login password information, etc.

Step S402, identification information and account information of the controlled device 2 are sent.

The application control terminal 3 sends the acquired identification information and account information of the controlled device 2 to the main control device 1 so as to enable the main control device to log in the controlled device 2.

Step S403, a network connection is established.

After receiving the information of the controlled device 2, the main control device 1 interacts with the controlled device according to the identification information of the controlled device 2, and a network connection is established between the both.

Step S404, log in using the account information.

When the network connection between the main control device 1 and the controlled device 2 is established, the main control device 1 logs in the controlled device 2 using the account information.

Step S405, authorization login information is sent.

After receiving the login request of the main control device, the controlled device 2 verifies the login request, and sends authorization login information to the main control device after the verification is passed, so as to allow the main control device 1 to login in.

Step S406, an association request is sent.

After the main control device 1 logs in the controlled device 2 via the account information, an association request is sent to the controlled device 2, the main control device 1 and the controlled device 2 are bound.

Step S407, an association relationship is established.

The controlled device 2 agrees to establish an association relationship with the main control device 1 according to an association request sent by the main control device 1.

Step S408, token information is generated.

After the controlled device 2 establishes an association relationship with the main control device 1, the token information is generated for the main control device 1, so that the main control device 1 can perform logging according to the token information in a subsequent login operation.

Step S409, token information is sent.

The controlled device 2 sends the generated token information to the main control device 1.

Step S4091, it returns an association result.

After receiving the token information sent by the controlled device 2, the main control device 1 confirms that the association with the controlled device 2 is successful, and then it returns an association result to the application control terminal 3, so that the association control terminal 3 can monitor the association process.

The above-mentioned signaling interaction process is a set-up flow performed by the main control device 1 and the controlled device 2 under the control of the application control terminal 3, and the process of the controlled device 2 issuing token information to the main control device 1 is achieved by this flow.

FIG. 9 is a signaling interaction diagram for the coordinated control of the controlled device by the main control device according to the embodiment of the present application. In the present embodiment, the description is made based on the network architecture of FIG. 1A or FIG. 1B, and the signaling interaction process of the main control device 1 performing linkage control on the controlled device 2 includes the steps below:

Step S410, detection information monitored by a main control device 1 in real time is acquired, a linkage type corresponding to the detection information is determined, and address information and execution information of the controlled device 2 which is required to perform a linkage operation according to the linkage type are determined based on a pre-set linkage parameter table.

The main control device 1 detects a pre-set area, acquires detection information, analyzes the detection information, determines a corresponding linkage type, and determines address information and execution information of the controlled device 2 by querying a linkage parameter table according to the linkage type.

Step S420, a network connection request is sent.

The main control device 1 sends a network connection request to the controlled device 2 according to the address information of the controlled device 2.

Step S430, a network connection is established.

The main control device 1 and the controlled device 2 establish a network connection by a local area network or a P2P network.

Step S440, a login request is sent.

The main control device 1 initiates a login request to the controlled device 2, wherein the login request includes token information, and the token information is issued by the controlled device 2 to the main control device 1.

Step S450, the token information is verified.

The controlled device 2 verifies the token information sent by the main control device 1.

Step S460, authorization login information is sent.

If the controlled device 2 verifies the token information, the main control device 1 is allowed to log in, and the authorization login information is sent to the main control device 1, so that the main control device 1 logs in the controlled device 1.

Step S470, execution information is sent.

After the main control device 1 logs in the controlled device 2, it sends execution information to the controlled device 2.

Step S480, a linkage operation is executed.

The controlled device 2 performs a linkage operation according to the execution information.

It can be seen from FIGS. 8 and 9 that in the device linkage control system provided in the embodiment of the present application, after detecting information, a main control device 1 determines a target controlled device according to a linkage type by querying a linkage parameter table, the controlled device 2 interacts with token information generated in advance by the controlled device 2, and execution information is sent to the controlled device 2, so as to achieve a linkage operation on the controlled device 2. The whole linkage process does not require the participation of a cloud platform, and also does not require a user to input any account and password information, which improves the timeliness of the linkage operation, reduces the delay of the linkage operation, and also reduces the operational difficulty of the linkage operation and improves the user's experience.

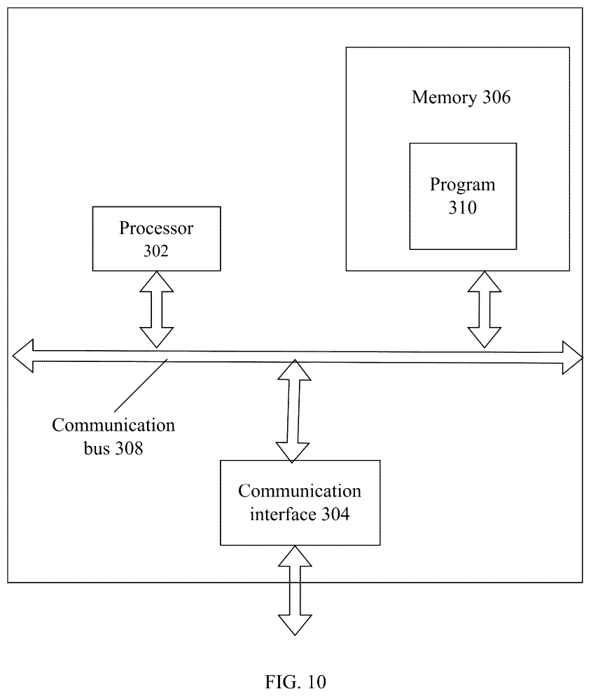

FIG. 10 shows a schematic structural diagram of a main control device 1 or a controlled device 2 provided by an embodiment of the present application, and the specific embodiment of the present application does not limit the specific implementation of the main control device 1 or the controlled device 2.

As shown in FIG. 10, the main control device 1 or the controlled device 2 may include a processor 302, a communication interface 304, a memory 306, and a communication bus 308.

Here, the processor 302, the communication interface 304, and the memory 306 communicate with each other via the communication bus 308. The communication interface 304 is configured for communicating with network elements of other devices such as clients or other servers, etc. The processor 302 is configured for executing the program 310, and can specifically perform the relevant steps in the embodiment of the device linkage control method applied to the main control device side or applied to the controlled device side provided in the above-mentioned embodiment.

In particular, a program 310 may include program code that includes computer-executable instructions. In the present embodiment, the program 310 is one or more program function modules for implementing the device linkage control method described herein, and may be invoked by a processor to cause a main control device or a controlled device to execute various method steps for implementing the device linkage control method described herein.

The processor 302 may be a central processing unit CPU, or an ASIC (Application Specific Integrated Circuit), or one or more integrated circuits configured to implement embodiments of the present application. One or more processors included in the main control device may be the same type of processor, such as one or more CPU. It may also be a different type of processor, such as one or more CPU and one or more ASIC.

The memory 306 is configured for storing the program 310. The volatile memory 306 may include a high-speed RAM memory, but may also include a non-volatile memory, such as at least one disk memory.

Embodiments of the present application also provide a computer program that can be called by a processor to cause a main control device or a controlled device to execute a device linkage control method in any of the above-mentioned method embodiments.

Embodiments of the present application provide a computer program product including a computer program stored on a computer-readable storage medium, the computer program including program instructions that, when executed on a computer, cause the computer to perform the device linkage control method in any of the above-described method embodiments.

The algorithms or displays presented herein are not inherently related to any particular computer, virtual system, or other apparatus. Various general-purpose systems may also be used with the teachings based herein. The structure required to construct such a system will be apparent from the above description. In addition, embodiments of the present application are also not directed to any particular programming language. It will be appreciated that a variety of programming languages may be used to implement the teachings of the present application as described herein, and the above description of specific languages is provided to disclose the best mode of performing the present application.

In the device linkage control method and system provided in the embodiments of the present application, the controlled device 2 issues token information to the main control device in advance, so that the main control device 1 can access the controlled device 2 via the token information when needed. When the main control device 1 is required to perform linkage control on the controlled device 2, it does not need to operate via any cloud platform, and is only required to directly establish a connection with the controlled device 2. After the connection is established, the main control device 1 directly accesses the controlled device 2 via the token information pre-issued by the controlled device 2. The controlled device 2 verifies the main control device 1 according to the token information. After the verification is passed, the main control device 1 directly sends linkage execution information to control the controlled device 2, thereby achieving the direct control of the main control device I on the controlled device. The linkage control method provided in the embodiments of the present application. On the one hand, by way of pre-issuing a token, it does not need to perform security authentication via a server, and the token is directly issued by the controlled device 2, thus ensuring the security problem between the main control device 1 and the controlled device 2. On the other hand, the main control device 1 and the controlled device 2 are directly connected, which solves the real-time problem of linkage control, and does not need any interaction by the cloud platform. The IoT device is not required to connect to the external network, and it is not required to build any cloud platform. The present application is simple and convenient to achieve, has high security, and also reduces the cost of linkage between the IoT devices. Therefore, the device linkage control method and system proposed in the present application solve the problems of low real-time linkage and low security among different IoT devices existing in the prior art.

It should be noted that the above-mentioned embodiments illustrate rather than limit the present application, and that those skilled in the art will be able to design alternative embodiments without departing from the scope of the present application. The steps in the above-described embodiments, unless otherwise specified, should not be construed as limiting the order of execution.

What is claimed is:

1. A device linkage control method applied to a main control device, the method comprising:
acquiring detection information monitored by the main control device, and determining a linkage type corresponding to the detection information;
determining a controlled device required to perform a linkage operation based on a preset linkage parameter table and the linkage type, and acquiring address information and execution information of the controlled device from the linkage parameter table;
establishing a network connection with the controlled device according to the address information;
sending token information to the controlled device to verify validity of the token information;
receiving authorization login information sent by the controlled device, and enable the main control device to log in the controlled device when the token information is valid; and
sending the execution information to the controlled device through the network connection, so that the controlled device performs a linkage operation according to the execution information.

2. The method according to claim 1, further comprising:
receiving identification information and account information of the controlled device sent by an application control terminal;
initiating a network connection to the controlled device according to the identification information, and logging in the controlled device using the account information; and
initiating an association request to the controlled device, and receiving the token information sent by the controlled device.

3. The method according to claim 1, wherein the process of determining the controlled device based on the preset linkage parameter table and the linkage type, comprises:
judging whether there is a controlled device having established an association with the main control device in the linkage parameter table;
if there is a controlled device having established an association with the main control device in the linkage parameter table, determining that the controlled device is required to perform the linkage operation according to the linkage type; and
if there is no controlled device having established an association with the main control device in the linkage parameter table, executing the process of acquiring the detection information monitored by the main control device in real time and determining the linkage type according to the detection information.

4. The method according to claim 1, further comprising:
recording time information corresponding to the detection information;
wherein the process of determining the controlled device required to perform the linkage operation based on the preset linkage parameter table and the linkage type, comprises:
determining a linkage time range corresponding to the linkage type;
if the time information corresponding to the detection information is within the linkage time range, determining that the controlled device corresponding to the linkage type is to require to perform the linkage operation.

5. The method according to claim 4, further comprising:
receiving a linkage operation result sent by the controlled device, wherein the linkage operation result comprises a time stamp of the controlled device performing a linkage operation according to the execution information;
judging whether a linkage delay occurs to the controlled device according to the time information and the time stamp; and
if a linkage delay occurs to the controlled device, sending address information of the controlled device where the linkage delay occurs to the application control terminal.

6. The method according to claim 1, wherein the token information is generated by the controlled device when establishing an association with the main control device, and sent to the main control device so as to enable the main control device to log in the controlled device.

7. A device linkage control method applied to a controlled device, the method comprising:
receiving a network connection request sent by a main control device, and establishing a network connection with the main control device;
receiving token information sent by the main control device;
verifying the token information and generating authorization login information after the verification is passed;
sending the authorization login information to the main control device for enabling the main control device to log in the controlled device;
receiving execution information sent by the main control device through the network connection; and
performing a linkage operation according to the execution information.

8. The method according to claim 7, further comprising:
receiving account information sent by the main control device, wherein the account information is sent to the main control device by an application control terminal;
verifying the account information, and receiving an association request sent by the main control device;
generating the token information after establishing an association with the main control device; and
sending the token information to the main control device.

9. The method according to claim 7, wherein the process of performing a linkage operation according to the execution information comprises:
judging whether the execution information is the same as current execution information on a current operation being executed by the controlled device;
if the execution information is the same as the current execution information, performing the linkage operation according to the execution information after performing the current operation; and
if the execution information is different from the current execution information, ignoring or rejecting the execution information according to a pre-set execution strategy, or performing the linkage operation according to the execution information after performing the current operation.

10. The method according to claim 7, wherein the token information is generated by the controlled device when establishing an association with the main control device, and sent to the main control device so as to enable the main control device to log in the controlled device.

11. A device linkage control system, comprising:
a main control device and one or more controlled devices, wherein:
the main control device is configured for monitoring detection information in real time, determining a linkage type corresponding to the detection information, determining one of the controlled devices required to perform a linkage operation based on a preset linkage parameter table and the linkage type, and acquiring address information and execution information of the controlled device from the linkage parameter table, sending a network connection request to the controlled device according to the address information; and
the controlled device is configured for establishing a network connection with the main control device according to the network connection request, receiving token information sent by the main control device, verifying the token information and generating authorization login information after the verification is passed, and sending the authorization login information to the main control device for enabling the main control device to log in the controlled device, receiving execution information sent by the main control device through the network connection, and performing a linkage operation according to the execution information.

12. The system according to claim 11, further comprising an application control terminal, wherein the application control terminal is configured respectively for establishing a network connection with the main control device and the controlled device, acquiring identification information and account information of the controlled device, and sending the identification information and account information of the controlled device to the main control device.

13. The system according to claim 12, wherein the main control device is further configured for initiating a network connection to the controlled device according to the identification information, and logging in the controlled device using the account information after establishing the network connection with the controlled device.

14. The system according to claim 12, wherein the controlled device is further configured for verifying the account information, generating authorization login information after the verification is passed, and sending the authorization login information to the main control device.

15. The system according to claim 11, wherein the main control device is further configured for initiating an association request to the controlled device after receiving the authorization login information.

16. The system according to claim 11, wherein the controlled device is further configured for establishing an association with the main control device according to the association request, generating the token information, and sending the token information to the main control device.

17. The system according to claim 11, wherein the token information is generated by the controlled device when establishing an association with the main control device, and sent to the main control device so as to enable the main control device to log in the controlled device.
